(19) United States
(12) Patent Application Publication
(10) Pub. No.: US 2013/0247083 A1
(43) Pub. Date: Sep. 19, 2013

(54) SYSTEMS AND METHODS FOR MATCHING AN ADVERTISEMENT TO A VIDEO

(71) Applicant: SET MEDIA, INC., San Francisco, CA (US)

(72) Inventors: Robert Philip IMPOLLONIA, San Mateo, CA (US); Michael Gregory SULLIVAN, San Francisco, CA (US); Ali ZANDIFAR, San Francisco, CA (US)

(73) Assignee: SET MEDIA, INC., San Francisco, CA (US)

(21) Appl. No.: 13/889,019

(22) Filed: May 7, 2013

Related U.S. Application Data
(63) Continuation of application No. 12/757,276, filed on Apr. 9, 2010.

(51) Int. Cl. H04N 21/81

(52) U.S. Cl. CPC H04N 21/812
USPC 725/14

(57) ABSTRACT

Systems and methods for automatically matching in real-time an advertisement with a video desired to be viewed by a user are provided. A database is created that stores one or more attributes (e.g., visual metadata relating to objects, faces, scene classifications, pornography detection, scene segmentation, production quality, fingerprinting) associated with a plurality of videos. Supervised machine learning can be used to create signatures that uniquely identify particular attributes of interest, which can then be used to generate the attributes associated with the plurality of videos. When a user requests to view an on-line video having associated with it an advertisement, an advertisement can be selected for display with the video based on matching an advertiser's requirements or campaign parameters with the stored attributes associated with the requested video, with the user's information, or a combination thereof. The displayed advertisement can function as a hyperlink that allows a user to select to receive additional information about the advertisement. The performance or effectiveness of the selected advertisements can be measured and recorded.

### CROSS REFERENCE TO RELATED APPLICATIONS

This application is a continuation of and claims priority under 35 U.S.C. §120 to U.S. Utility application Ser. No. 12/757,276, filed on Apr. 9, 2010, entitled “Systems and Methods for Matching an Advertisement to a Video,” the contents of which are incorporated by reference in their entirety.

### BACKGROUND OF THE INVENTION

1. Technical Field

The present invention relates to on-line targeted advertising. More particularly, the present invention relates to systems and methods for automatically matching in real-time an advertisement with a video desired to be viewed by a user.

2. Description of the Related Art

Advertisements can be combined with on-line content in a number of different ways. For example, advertisements can be selected that are unrelated to a user or the on-line content. As another example, advertisements can be targeted such that they are selected based on information about the user. This information can include, for example, a user's cookie information, a user's profile information, a user's registration information, the types of on-line content previously viewed by the user, and the types of advertisements previously responded to by the user. In yet another example, targeted advertisements can be selected based on information about the on-line content desired to be viewed by the user. This information can include, for example, the websites hosting the content, the selected search terms, and metadata about the content provided by the website. In a further example, advertisements can be combined with on-line content using a combination of these approaches.

There are known systems and methods for combining advertisements with on-line content that includes textual content and/or static images. In these known systems and methods, targeted advertisements are typically selected based on the textual content itself and metadata associated with the textual content and/or static images.

There are also known systems and methods for combining advertisements with on-line content that includes videos. However, such videos have a limited amount of metadata associated with them. The metadata includes general information about the video including the category (e.g., entertainment, news, sports) or channel (e.g., ESPN, Comedy Central) associated with the video. The metadata does not include more specific information about the video such as the visual and/or audio content of the video. Because videos have a limited amount of metadata associated with them, the ability for these known systems and methods to target advertisements based on the visual and/or audio contents of videos in a meaningful way is extremely limited.

Therefore, there is a need in the art to provide a way to target advertisements based on the visual and/or audio contents of videos in a meaningful way.

Accordingly, it is desirable to provide methods and systems that overcome these and other deficiencies of the prior art.

### SUMMARY OF THE INVENTION

In accordance with the present invention, systems and methods are provided for for learning visual signatures for identifying an element in a video. A method can include initiating a detector for detecting the element in the video, and collecting and storing a first plurality of video samples to a first database. The method can further include labeling the stored first plurality of video samples by identifying occurrences of the element in the stored first plurality of video samples. The method can further include training the detector by building a unique signature for the element based on the identified occurrences of the element in the stored first plurality of video samples and evaluating the detector by measuring an ability of the detector to detect the element in the video. According to aspects of the disclosure, when a result of evaluating the detector is below a first threshold, the method can return to the step of collecting and storing to collect and store a second plurality of video samples; and when the result of evaluating the detector is above the first threshold, the method can bootstrap the detector, wherein bootstrapping comprises collecting a third plurality of video samples each containing the element and returning to the step of training the detector to improve the accuracy of the detector.

According to embodiments of the present invention, when the result of evaluating the detector is above a second threshold, the method for learning visual signatures can terminate.

According to embodiments of the present invention, initiating the detector includes providing a detector description and detector parameters.

According to embodiments of the present invention, the detector parameters comprise at least one of a size of search, priority, due date, and minimum accuracy.

According to embodiments of the present invention, collecting the first plurality of video samples can include receiving a plurality of uniform resource locators (URLs) each associated with one of the first plurality of video samples and downloading the first plurality of video samples at the plurality of URLs.

According to embodiments of the present invention, labeling the stored first plurality of video samples further can include indicating which frames or portions of the stored first plurality of video samples include the element.

According to embodiments of the present invention, indicating the frames or portions of the stored video samples can include drawing a shape around the element on the frames or portions of the stored first plurality of video samples.

According to embodiments of the present invention, the method can include tracking the element in subsequent frames of the stored first plurality of video samples.

According to embodiments of the present invention, the method can include estimating the location of the element in subsequent frames of the stored first plurality of video samples.

According to embodiments of the present invention, the method can include correcting the estimated location of the element.

According to embodiments of the present invention, the method can include storing the unique signature for the element in a second database.

According to embodiments of the present invention, evaluating the detector can include measuring a number of times the unique signature detects the element.

According to embodiments of the present invention, evaluating the detector can include measuring a percentage of times the unique signature detects the element.

According to embodiments of the present invention, bootstrapping the detector can include validating the accuracy of the detector.

According to embodiments of the present invention, the method can include recording the validation results in the first database.

Systems and methods for automatically matching in real-time an advertisement with a video desired to be viewed by a user are also provided. A database is created that stores one or more attributes, such as visual and/or audio metadata, associated with a plurality of videos. The attributes can be based on parameters such as objects, faces, scene classification, pornography detection, scene classification, production quality, and fingerprinting. Learning visual signatures can be used to create signatures that uniquely identify particular attributes of interest, which can then be used to generate the attributes associated with the plurality of videos.

When a user requests to view an on-line video having associated with it an advertisement, an advertisement can be selected for display with the video to the user in real-time. The advertisement can be selected based on matching an advertiser's requirements or campaign parameters with the stored attributes associated with the requested video, with the user's information, or a combination thereof. The selected advertisement that best matches, which can be an Adobe Flash advertisement or other suitable advertisement, is then sent to the user for display. The advertisement can include function as a hyperlink that allows a user to select to receive additional information about the advertisement. The performance or effectiveness of the selected advertisements can also be measured and recorded.

According to one or more embodiments of the invention, a method is provided for automatically matching in real-time an advertisement with a video desired to be viewed by a user comprising the steps of: maintaining a database that stores visual metadata associated with each of a plurality of videos; storing advertiser requirements associated with each of the plurality of advertisements; receiving in real-time information regarding the video desired to be viewed by the user; processing the visual metadata stored in the database for the video desired to be viewed by the user with the advertiser requirements to determine which of the plurality of advertisements has requirements that meet the visual metadata of the video desired to be viewed by the user; and selecting an advertisement from the plurality of advertisements based on the processing, wherein the advertisement has requirements that most closely meet the visual metadata of the video desired to be viewed by the user.

According to one or more embodiments of the invention, a system is provided for automatically matching in real-time at least one of a plurality of advertisements with a video desired to be viewed by a user, the system comprising: a first database that stores visual metadata associated with each of a plurality of videos; a second database that stores the plurality of advertisements and advertiser requirements associated with each of the plurality of advertisements; and a server computer coupled to the first database and the second database, and operative to: receive in real-time information regarding the video desired to be viewed by the user, process the visual metadata stored in the first database for the video desired to be viewed by the user with the advertiser requirements stored in the second database to determine which of the plurality of advertisements has requirements that meet the visual metadata of the video desired to be viewed by the user, and select an advertisement from the plurality of advertisements stored in the second database based on the processing, wherein the advertisement has requirements that most closely meet the visual metadata of the video desired to be viewed by the user.

According to one or more embodiments of the invention, a method is provided for automatically matching in real-time at least one of a plurality of advertisements with a video desired to be viewed by a user, the method comprising: processing each of a plurality of videos using at least one of object detection, face recognition, and scene classification to generate attributes associated with each of the plurality of videos; maintaining a database that stores the attributes associated with each of the plurality of videos; storing advertiser requirements associated with each of the plurality of advertisements; receiving in real-time information regarding the video desired to be viewed by the user; processing the attributes stored in the database for the video desired to be viewed by the user with the advertiser requirements to determine which of the plurality of advertisements have requirements that meet the attributes of the video desired to be viewed by the user; and selecting an advertisement from the plurality of advertisements based on the processing, wherein the advertisement has requirements that most closely meet the attributes of the video desired to be viewed by the user.

According to one or more embodiments of the invention, a system is provided for automatically matching in real-time at least one of a plurality of advertisements with a video desired to be viewed by a user, the system comprising: a sever computer operative to process each of a plurality of videos using at least one of object detection, face recognition, and scene classification to generate attributes associated with each of the plurality of videos; a first database that stores the attributes associated with each of the plurality of videos; and a second database that stores the plurality of advertisements and advertiser requirements associated with each of the plurality of advertisements, wherein the server computer is coupled to the first database and the second database, and is further operative to: receive in real-time information regarding the video desired to be viewed by the user, process the attributes stored in the first database for the video desired to be viewed by the user with the advertiser requirements stored in the second database to determine which of the plurality of advertisements have requirements that meet the attributes of the video desired to be viewed by the user, and select an advertisement from the plurality of advertisements based on the processing, wherein the advertisement has requirements that most closely meet the attributes of the video desired to be viewed by the user.

According to one or more embodiments of the invention, a method is provided for automatically maintaining a database that stores attributes associated with each of a plurality of videos for use in matching in real-time at least one of a plurality of advertisements with a video desired to be viewed by a user, the method comprising: selecting at least one of a plurality of videos; processing the video to generate attributes associated with the video, wherein the processing further comprises downloading the video, decoding and decompressing the video into a plurality of frames, and processing data from at least one of the plurality of frames based on at least one of object detection, face recognition, and scene classification to generate the attributes associated with the video; and storing the attributes associated with the video in the database, wherein upon receiving in real-time information regarding the video that is desired to be viewed by the user, the method further comprises processing the attributes stored in the database for the video with advertiser requirements associated with each of the plurality of advertisements to determine which of the plurality of advertisements have requirements that meet the attributes of the video desired to be viewed by the user.

According to one or more embodiments of the invention, a system is provided for automatically maintaining a database that stores attributes associated with each of a plurality of videos for use in matching in real-time at least one of a plurality of advertisements with a video desired to be viewed by a user, the system comprising: a database; and a server computer coupled to the database and operative to: select at least one of a plurality of videos, process the video to generate attributes associated with the video, which comprises downloading the video, decoding and decompressing the video into a plurality of frames, and processing data from at least one of the plurality of frames based on at least one of object detection, face recognition, and scene classification to generate the attributes associated with the video, and store the attributes associated with the video in the database, wherein upon receiving in real-time information regarding the video that is desired to be viewed by the user, the server computer is further operative to process the attributes stored in the database for the video with advertiser requirements associated with each of the plurality of advertisements to determine which of the plurality of advertisements have requirements that meet the attributes of the video desired to be viewed by the user.

According to one or more embodiments of the invention, a method is provided for automatically matching in real-time at least one of a plurality of advertisements with a video desired to be viewed by a user, the method comprising: maintaining a database that stores attributes associated with each of a plurality of videos; storing advertiser requirements associated with each of the plurality of advertisements; receiving in real-time a request for an Adobe Flash file associated with a video desired to be viewed by the user; delivering the Flash file to the user; receiving in real-time information about the user and regarding the video desired to be viewed by the user in response to delivering the Flash file; processing the attributes stored in the database for the video desired to be viewed by the user and the information about the user with the requirements to determine which of the plurality of advertisements have requirements that meet the attributes of the video desired to be viewed by the user; and selecting an advertisement from the plurality of advertisements based on the processing, wherein the advertisement has requirements that most closely meet the attributes of the video desired to be viewed by the user.

According to one or more embodiments of the invention, a method is provided for automatically maintaining a database that stores signatures for attributes of interest associated with videos for use in matching in real-time at least one of a plurality of advertisements with a video desired to be viewed by a user, the method comprising: downloading from at least one publisher a first set of videos likely to have an attribute of interest; processing a set of videos, wherein the processing comprises decoding and decompressing the set of videos into a plurality of frames, receiving first information as to a which of the plurality of frames (a first subset of frames) includes the attribute of interest, and receiving second information as to where in each of the first subset of frames the attribute of interest is located; generating a signature for the attribute of interest based on the second information from a portion of the first subset of frames (a second subset of frames); applying the signature to a remaining portion of the first subset of frames; and determining whether the signature accurately identifies the attribute of interest in the remaining portion of the first subset of frames: if the signature accurately identifies the attribute of interest, storing the signature in the data, and if the signature does not accurately identify the attribute of interest, processing a new set of videos using a detector signature to generate additional training data to use to build a more accurate signature.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with the other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a block diagram illustrating an on-line video advertising marketplace in accordance with an embodiment of the invention.

FIG. 2 is a block diagram illustrating an optimized advertisement delivery system in accordance with an embodiment of the invention.

FIG. 3 is a block diagram illustrating an optimized advertisement delivery system in accordance with an embodiment of the invention.

FIG. 4 is a diagram illustrating delivery of standard Adobe Flash advertisement with a variable payload in accordance with an embodiment of the invention.

FIG. 5 is a diagram illustrating a video processing pipeline in accordance with an embodiment of the invention.

FIG. 6 is a block diagram illustrating an individual worker machine within a video processing pipeline in accordance with an embodiment of the invention.

FIG. 7 is a flow chart illustrating processes for object detection and face recognition in accordance with an embodiment of the invention.

FIG. 8 is a flow chart illustrating a process for scene classification in accordance with an embodiment of the invention.

FIG. 9 is a flow chart illustrating a process for learning visual signatures in accordance with an embodiment of the invention.

FIGS. 10A and 10B show an illustrative example of a process 1000 for learning visual signatures in accordance with an embodiment of the invention.

### DETAILED DESCRIPTION OF THE INVENTION

In the following description, numerous specific details are set forth regarding the systems and methods of the present invention and the environment in which such systems and methods may operate, etc., in order to provide a thorough understanding of the present invention. It will be apparent to one skilled in the art, however, that the present invention may be practiced without such specific details, and that certain features, which are well known in the art, are not described in detail in order to avoid complication of the subject matter of the present invention. In addition, it will be understood that the examples provided below are exemplary, and that it is contemplated that there are other systems and methods that are within the scope of the present invention.

In accordance with the present invention, systems and methods are provided for automatically matching in real-time an advertisement with a video desired to be viewed by a user. A database is created that stores one or more attributes associated with a plurality of videos. These attributes can include any information about the content of the video including the visual and/or audio content or metadata. For example, the attributes can include the identity of objects in a video (e.g., a ball, a car, a human figure, a face, a logo such as the Nike™ swoosh or NBC peacock, a product such as a cellular telephone or television, a character such as Mickey Mouse or Snoopy), the identity of faces in a video (e.g., Julia Roberts, Tom Hanks, David Letterman), the type or classification of a scene in a video (e.g., a beach scene, a sporting event such as a basketball game, a talk show), the detection of pornography in a video (e.g., no pornography, pornography with a particular level of explicitness), the scene segmentation (e.g., identification of scene breaks), the production quality of a video (e.g., high or professional, average, or low production quality), a fingerprint, the type of language in the video (e.g., English, Spanish, presence or absence of curse words), the types of attributes associated with an advertiser's requirements, or any other suitable information or combination of information about the video content. Any suitable hardware and/or software can be used to process, generate, and store these attributes associated with the videos.

The database can be created in any suitable way. In one embodiment, the database can be created during the initial set-up of the system, for example, before any user requests to view a video having associated with it an advertisement. After the initial set-up of the system, the database can be updated to include any additional attributes about videos already stored in the database and/or to include attributes about new videos. In another embodiment, the database can be created in real-time by processing, generating, and storing attributes about videos the first time that the videos are requested by users. Thereafter, the database can be updated to include any additional attributes about the videos already stored in the database. In both embodiments, the database can be updated automatically, manually, or in any other suitable way or combination of ways. The database can also be updated at select times (e.g., once, more than once), periodically (e.g., daily, weekly, monthly), in response to user requests to view a video (e.g., based on new videos whose attributes are not stored in the database), in response to advertiser requirements (e.g., based on attributes not previously stored about the videos), based on a predetermined condition (e.g., after a particular number of video requests), or at any other suitable time/condition or combination of times/conditions. Once attributes about a video are stored in the database, any subsequent request by a user to view the video will allow for an advertisement to be matched with the video in real-time.

In order to generate and store attributes associated with a plurality of videos, the present invention uses learning visual signatures to create signatures that uniquely identify particular attributes of interest. For example, signatures can be created that uniquely identify particular objects, faces, scene types, or any other suitable depiction or combination of depictions in a video. A signature can be created for an object, face, and/or scene type of interest by collecting a sample set of videos known to have the object, face, and/or scene type of interest, processing the videos to identify and label which frames and where in the frames the object, face, and/or scene type appears, building an initial detector signature based on a subset of the labeled frames using a suitable supervised machine learning algorithm, and testing the detector signature against the remainder of the labeled frames to determine whether the signature can accurately identify the object, face, and/or scene type. Based on the testing, further processing, including collecting and processing a new video sample set, may be required to generate a more accurate signature.

When a user requests to view an on-line video having associated with it an advertisement, an advertisement can be selected for display with the video to the user in real-time. In one embodiment, the advertisement can be selected based on matching the requirements of one or more advertisers with the stored attributes associated with the requested video. In another embodiment, the advertisement can be selected based on matching the requirements of one or more advertisers with the user's information such as cookie, profile, and/or registration information. In yet another embodiment, the advertisement can be selected based on matching the requirements of one or more advertisers with a combination of the stored attributes and the user's information. The selected advertisement can be the one with the best match, which can be determined using any suitable approach. For example, the matching advertisement for which the advertiser is willing to pay the highest price may be chosen. Alternately, the matching advertisement that is the most narrowly targeted (expected to match the fewest portion of available videos) may be chosen.

The advertiser's requirements, or campaign parameters, can include, for example, creative assets, a start time, an end time, a bid amount, content requirement, audience requirement, or any other suitable parameter or combination of parameters. As an illustration, an advertiser, such as Nike™, could specify that it wants to provide an advertisement for a limited edition pair of Nike Air basketball shoes. The advertiser could specify in the campaign parameters for the advertisement that the advertisement will be made available from Monday March 1 through Sunday March 7 for videos that meet the following requirements: are of a professional production quality, contain no pornography, depict a basketball game, and depict Michael Jordan. The campaign parameters could also include a maximum price (bid) that the advertiser is willing to pay per impression. This is merely illustrative and any other suitable campaign parameters or combination of parameters could be provided.

The selected advertisement that best matches the requested on-line video is then sent to the user. The advertisement can be text, an image, a video, an Adobe Flash file, or any combination thereof. The advertisement can be presented to the user in the same window as the video prior to the video being played, in another area of the webpage in which the video window appears, as an overlay ad, as a banner ad, as a pop-up ad, or in any other suitable way or combination of ways. The advertisement can also function as a hyperlink, allowing the user to click on the advertisement to be taken to a page with additional informationsuch as the advertiser's homepage. The performance or effectiveness of the selected advertisements can be measured and recorded in a database. For example, a record can be kept of the videos in which an advertisement is selected for display and/or the number of times that an advertisement is clicked on to view additional information.

The present invention provides several advantages. For example, the invention allows for a more reliable way to process and generate more specific information (e.g., visual and/or audio content or metadata) about a plurality of videos. By storing attributes about videos in a database, the invention also allows for advertisements to be matched with videos in real-time. The invention further allows for advertisers to provide better targeted advertisements for videos by specifying, using a variety of parameters, the types of videos with which to target advertisements.

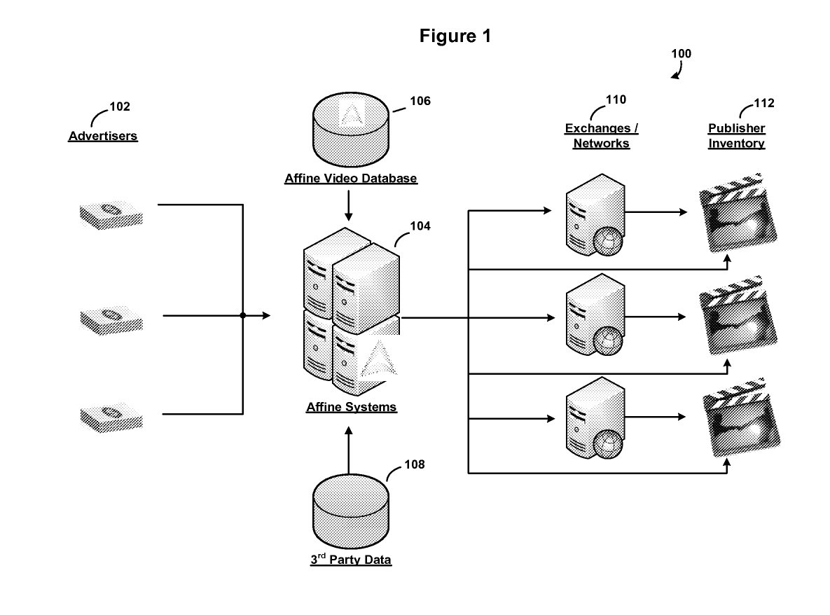

FIG. 1 is a block diagram illustrating an on-line video advertising marketplace 100 in accordance with an embodiment of the invention. Marketplace 100 includes advertisers 102, systems 104, a video database 106, a third party database 108, advertising exchanges and/or networks 110, and publisher 112. A company such as Affine, using systems 104, works on behalf of advertisers 102 to purchase advertising space (inventory) against on-lines videos. Systems 104 can be, for example, a computer, a network of computers, one or more servers, or any other suitable system or combination of systems. Advertisers 102 can be any entity who wishes to buy advertising impressions, including agencies acting on behalf of other companies. Systems 104 can purchase advertising space directly from publishers 112 or indirectly via exchanges and/or networks 110. Publishers 112 can be any company or website that hosts a video and offers advertising space to advertisers 102. The video views for which advertising space can be offered is the publisher's inventory. Exchanges and/or networks 110 can be market-making companies that bring together advertisements from advertisers 102 and inventories from publishers 112. Exchanges can be neutral while networks can make money on arbitrage. Exchanges typically operate in an automated fashion whereas networks perform transactions through salespeople.

Systems 104 can use video database 106 and/or third party data 108 to facilitate the purchasing of advertising space. Systems 104 can be used to process, generate, and store attributes (e.g., visual and/or audio metadata) about videos from publishers 112 in video database 106. Third party data 108 can be a database that stores additional information from third parties including advertisers 102 and publishers 112. This additional information can include, from advertisers 102, campaign parameters including how much advertisers 102 are willing to pay for advertising space. This additional information can also include, from publishers 112, metadata about the videos and how much publishers 112 are willing to charge for the advertising space. This additional information can also include demographic and information about users provided by publishers 112, advertisers 102, or other parties. Video database 106 and third party data 108 can be stored in any suitable storage medium or media, including one or more servers, magnetic disks, optical disks, semiconductor memories, some other types of memories, or any combination thereof. Systems 104 can use the data in video database 106 and/or third party data 108 to best match the advertising space for videos from publishers 112 (directly or via exchanges and/or networks 110) with the advertisements from advertisers 102.

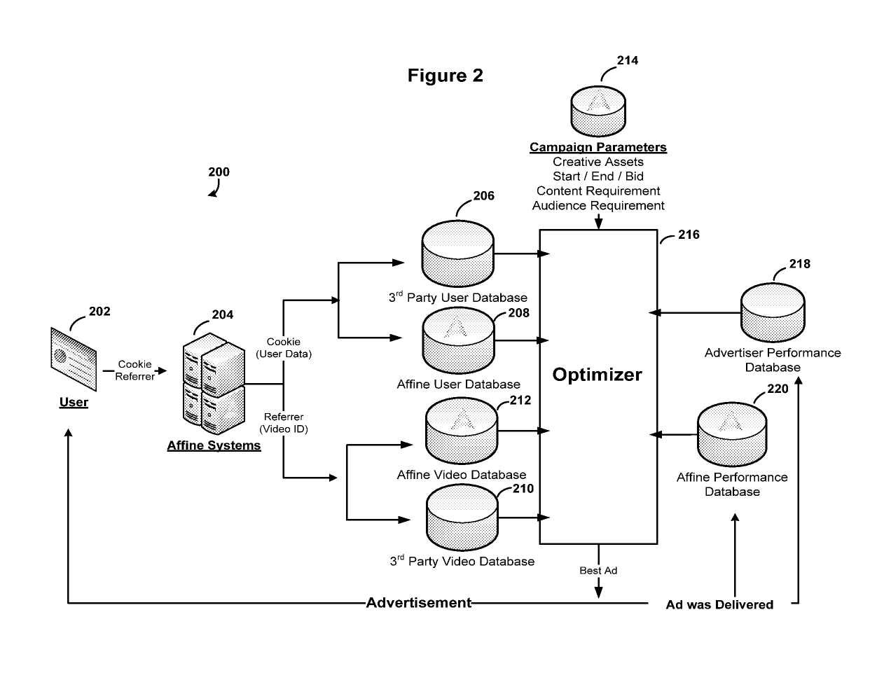

FIG. 2 is a block diagram illustrating an optimized advertisement delivery system 200 in accordance with an embodiment of the invention. Advertisement delivery system 200 illustrates the delivery of an advertisement when a user sends a request to watch an on-line video. Advertisement delivery system 200 includes a user at a computer 202, systems 204, user databases 206 and 208, video databases 210 and 212, advertiser database 214, an optimizer 216, and performance databases 218 and 220. A user at computer 202 can use a web browser to request a video or a webpage containing a video. In response to the user's request, the web browser sends a request to systems 204 for an advertisement to accompany the video. Systems 204 can be the same as systems 104 in FIG. 1.

This request to systems 204 can include cookie and referrer information. The cookie information is data about the user, such as profile and/or registration information, included in Hyper-Text Transfer Protocol (HTTP) cookies. Systems 204 uses the cookie information to look for and retrieve information about the user from the third party user database 206 and/or user database 208. The third party user database 206 includes information about the user known by a third party (including a publisher and/or data aggregator) based on the cookies (including demographic or other targeting data). The user database 208 includes information known about the user, which can include information from the third party and/or information independently collected. The third party user database 206 and user database 208 can be separate databases or combined into one database. The referrer can be identification of the requested video or web page containing the video included in an HTTP referrer header. Systems 204 uses the referred information to look for and retrieve information about the requested video from the third party video database 210 and/or the video database 212. The third party video database 210 includes information about the video known by a third party (including a publisher and/or data aggregator). The third party video database 210 can be the same as third party data 108 in FIG. 1. Video database 212 includes information about the requested video, which can include information from the third party and/or information independently collected. For example, video database 212 can include attribute information generated and stored for a requested video using any suitable algorithm including machine vision technology. The video database 212 can be the same as video database 106 in FIG. 1. The third party video database 210 and video database 212 can be separate databases or combined into one database. The information retrieved from any one or more of databases 206, 208, 210, and 212 are then sent to optimizer 216. The ad request can also include the price (cost) of the advertising impression, which is also sent to optimizer 216.

Optimizer 216 also receives as input campaign parameters 214 from one or more advertisers 101. Campaign parameters 214 can be a database that stores business parameters about an advertising campaign including the actual advertisement to be served, starting and ending dates, target demographics, content to be associated with, a bid or price, or any other suitable parameters or requirements.

Optimizer 216 further receives as input the performance history of the available advertisements from an advertiser performance database 218 and/or performance database 220. Advertiser performance database 218 includes information tracked by the advertiser itself or a third party acting on its behalf (including a publisher and/or data aggregator) about the effectiveness of an advertisement based on the content of the video and a user's profile. Performance database 220 includes information about the effectiveness of an advertisement based on the content of the video and a user's profile, which can include information from the third party and/or information independently collected. The effectiveness of an advertisement can be measured based on whether a user clicks on the advertisement to view additional information and whether the user ultimately purchases or subscribes to the product or service being advertised or expresses an interest in doing so. The advertiser performance database 218 and performance database 220 can be separate databases or combined into one database.

Optimizer 216 selects in real-time an advertisement to accompany the requested video based on the cookie information retrieved from user databases 206 and 208, the referrer information retrieved from video databases 210 and 212, the requirements of the active advertisement campaigns retrieved from campaign parameters 214, the performance history of the available advertisements retrieved from performance databases 218 and 220, and/or any other suitable combination thereof. The optimizer 216 can be any combination of hardware and/or software. For example, the optimizer 216 can be software running in a processor, microprocessor, computer, server, or other system. Optimizer 216 can be configured to evaluate all of the information received from databases 206, 208, 210, 212, 214, 218, and 220, and based on an algorithm or predetermined set of criteria, selects the appropriate advertisement to accompany the requested video.

Optimizer 216 then delivers the selected advertisement to user computer 202 for display. Optimizer 216 further sends a notification to advertiser performance database 218 and/or performance database 220 of which advertisement was delivered to accompany a requested video to user computer 202. In an alternative embodiment, optimizer 216 can notify the advertiser or another third party of the selected advertisement so that the advertiser or other third party can deliver the selected advertisement to user computer 202 for display. In another alternative embodiment, optimizer 216 can also notify the publisher or another third party of the maximum price (bid) that systems 204 are willing to pay for the impression. In this case, the selected advertisement may only be served if there are no higher bids from other parties. The bid to place for each advertisement can be fixed as part of campaign parameters 214 or may be adjusted depending on the appropriateness of the available impression for the advertisement.

Databases 206, 208, 210, 212, 214, 218, and 220 can be any suitable storage medium or media, including one or more servers, magnetic disks, optical disks, semiconductor memories, some other types of memories, or any combination thereof. Although databases 206, 208, 210, 212, 214, 218, and 220 are shown as separate databases, they can be arranged in any individual database and/or combination of databases.

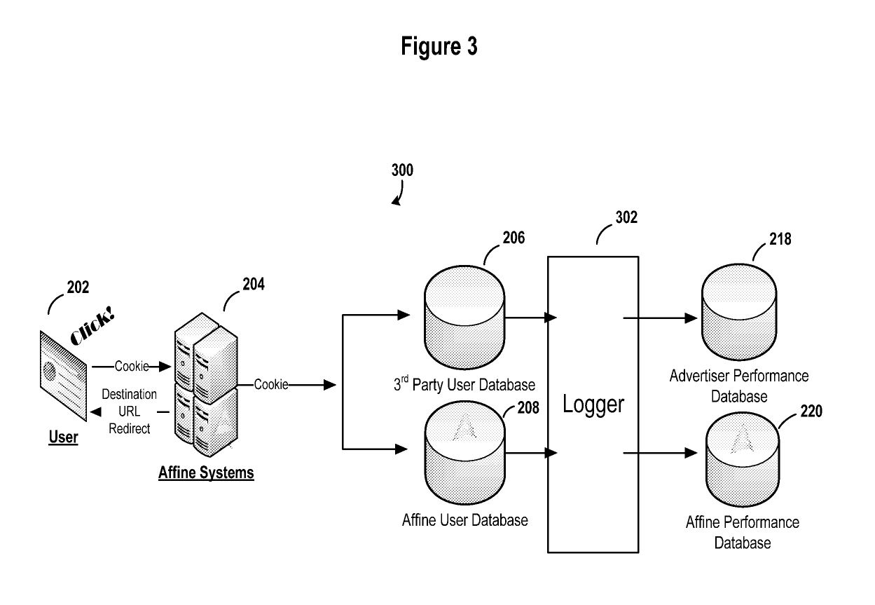

FIG. 3 is a block diagram illustrating an optimized advertisement delivery system in accordance with an embodiment of the invention. Advertisement delivery system 300 illustrates the performance tracking of an advertisement when a user has clicked on the advertisement. Advertisement delivery system 300 includes a user at computer 202, systems 204, user databases 206 and 208, a logger 302, and performance databases 218 and 220. As described above in connection with FIG. 2, when a user at computer 202 uses a web browser to request a video or a webpage containing a video, the user will receive a targeted advertisement with the video. The user can request to view additional information about the advertisement by clicking on the advertisement. In response to the user's request, the web browser sends a request to systems 204. Systems 204 can then redirect the user's web browser to a URL specified in the advertising campaign, which can be the home page of the advertiser or another web page.

Systems 204 can also retrieve cookie information from the request to look for and retrieve information about the user from the third party user database 206 and/or user database 208. Logger 302 uses the information from user databases 206 and 208 to log the user's click action in performance database 220 and/or to notify the advertiser performance database 219 of the user's click action. The logger 302 can be any combination of hardware and/or software. For example, the logger 220 can be software running in a processor, microprocessor, computer, server, or other system. Logger 220 can be configured to record a user's actions for selected advertisements to measure the performance history of the advertisements.

An advertisement can be presented to the user in a number of different ways, including, for example, in the same window as the video prior to the video being played, in another area of the webpage in which the video window appears, as an overlay ad, as a banner ad, or as a pop-up ad. A form of advertising used on many video hosting websites (e.g., YouTube.com) is the “overlay” ad. The overlay ad is a translucent banner image (which can be animated) that typically covers a portion (e.g., in the lower portion) of the video during a part of the video's run time. The overlay ad typically does not appear until a number of seconds (e.g., 15 seconds) into the video. The overlay ad can be clicked on to navigate to the advertiser's landing page (like a traditional banner ad). The overlay ad itself is typically a Flash (.swf) file containing an animated image (the ad “creative”).

In order to advertise on a video hosting website such as YouTube, an advertiser provides YouTube with its overlay ad file and the URL of their landing page. The advertisement itself is then served from YouTube's advertisement servers to each user who sees it and is linked to the requested landing page. Advertisers are limited by this approach because they cannot dynamically choose (at the time the advertisement is shown) which ad creative and landing page to use.

When the advertisement is implemented as a Flash object rather than a static image, the advertisement can contain executable code which can run as soon as the advertisement is loaded. This code can run inside the user's web browser while the video is being viewed. Because the advertisement is loaded immediately but does not appear until a number of second into the video, the advertisement will not be visible to the user at the time the code starts running.

The present invention takes advantage of this feature by allowing for dynamic advertisement and landing page selection for advertisers. In accordance with an embodiment of the invention, an advertisement is built to include a default ad creative as well as executable code. When the advertisement is loaded, the executable code runs and makes a request to Content Delivery Network (CDN) servers for an additional Flash (.swf) file. Log files for these CDN servers can indicate the number of times that the file has been requested, and thus the number of times YouTube has served the original advertisement (such as the number of impressions). This information can be used to validate the number of impressions as reported by YouTube. In online advertising, this is typically done by requesting an invisible image file (a pixel) rather than a Flash object. However, in accordance with the invention, the “pixel” is instead a Flash object, and thus can contain executable code that runs in the web browser when the pixel is loaded. This is known as a “smart pixel.”

Once the smart pixel is loaded, its executable code is run inside the user's web browser. The code can make requests to third parties who maintain databases of user information (e.g., BlueKai and eXelate). These third parties can identify the user via browser cookies sent along with each request and respond with any known information about the user. This information can also come from third party user database 206 in FIG. 2. The smart pixel can collect this information and sends it to the advertisement servers along with information about the video being watched. The information about the video being watched can also come from video databases 210 and/or 212 in FIG. 2. Based on this information and any user data of its own (which can come from user database 208 in FIG. 2), advertisement delivery system 200 (e.g., optimizer 216) performs advertisement matching to select an ad creative and landing page to use. The ad creative and landing page URL are sent back to the smart pixel, which uses this information to replace the default ad creative and URL from the original advertisement. If no response has been received before the time when the overlay ad is to appear in the video, the default ad creative and URL embedded in the original advertisement are used. Otherwise, the dynamically selected ad creative and URL are used instead.

Because the advertisement delivery system 200 (e.g., optimizer 216) performs the advertisement matching, new ad creatives can be added and/or targeting algorithms can be modified without needing to provide a new advertisement to YouTube. Changes to the code used in the smart pixel (e.g., to add additional data providers) can also be made by updating the smart pixel file hosted on the CDN servers without needing to provide a new advertisement to YouTube.

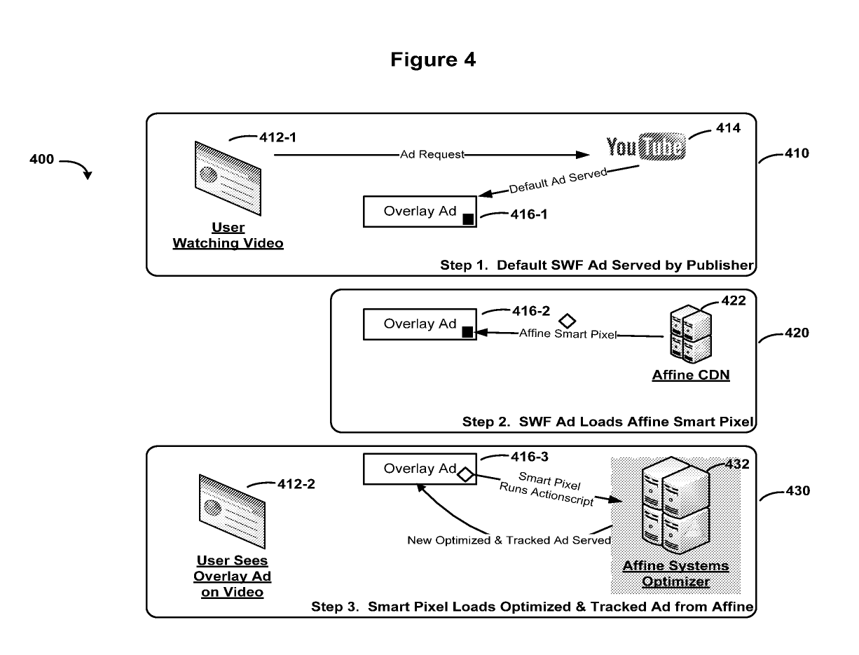

FIG. 4 is a diagram illustrating delivery of standard Flash advertisement with a variable payload 400 in accordance with an embodiment of the invention. Diagram 400 includes three steps. During Step 1 410, a default Flash (.swf) advertisement is served by a publisher. For example, a user at a computer 412 can request to view a video from a video hosting website such as YouTube 414. With this user request, computer 412 will also send an advertisement request to YouTube 414. YouTube 414 can be configured to play an overlay ad a number of seconds (such as 15 seconds) into the requested video. In response, YouTube 414 can send a default “wrapper” ad 416 that includes, for example, a default, non-optimized, non-trackable, ad creative asset, back to the user's computer 412. The default “wrapper” ad 416 can include a “smart pixel” request embedded therein.

During Step 2 420, the Flash (.swf) advertisement loads the “smart pixel.” For example, default “wrapper” ad 416 can send a request for the “smart pixel” from the CDN servers 422. In response, the CDN servers 422 can load the “smart pixel” into the “wrapper” ad 416-2 at the user's computer 412.

During Step 3 430, the “smart pixel” loads an optimized and tracked ad. For example, the “smart pixel” at the user's computer 412 can run an action script that calls on advertisement delivery system 200, in particular optimizer 216, to perform optimization based on at least cookie information from user databases 206 and/or 208 and/or referrer information from video databases 210 and/or 212, and serves back an optimized and tracked ad. An overlay ad with the optimized and tracked ad is then displayed in the video at the user's computer 412 at the appropriate time (e.g., 15 seconds into the requested video). However, in the event of a time-out in Steps 2 or 3, the user's computer 412 not receiving an optimized and tracked ad within the appropriate time, or other failure, the default ad can then be displayed in the video at the user's computer 412 at the appropriate time.

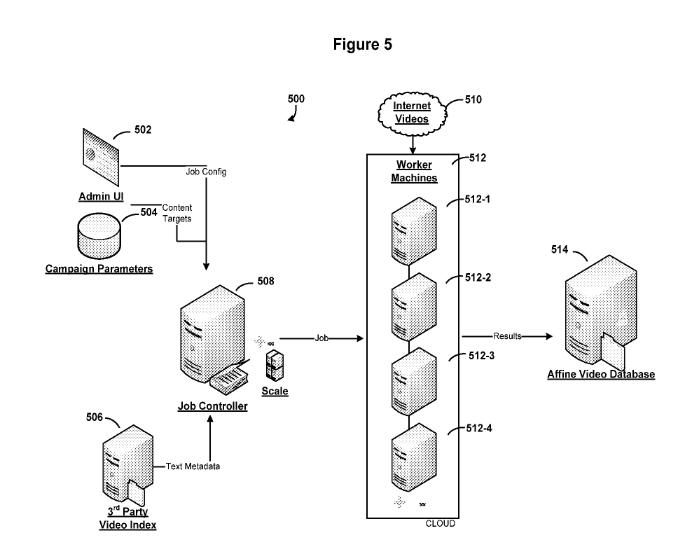

FIG. 5 is a diagram illustrating a video processing pipeline 500 in accordance with an embodiment of the invention. Video processing pipeline 500 illustrates the process by which videos are visually analyzed to generate and store attributes (or visual metadata text) about the videos in a database. Video processing pipeline 500 includes an administrative user interface 502, campaign parameters 504, third party video index 506, job controller 508, internet videos 510, worker machines 512, and a video database 514. The process is managed by job controller 508, which generates a list of potentially relevant videos for an advertising campaign based on job configurations from administrative user interface 502 and content targets from campaign parameters 504. Job controller 508 can be a computer, a network of computers, or any other suitable system. Administrative user interface 502 allows users to initiate and define an advertising campaign. Job controller 508 receives from interface 502 job configurations for processing or scanning the videos, including the breadth of the scan, output destinations, run-times, or any other suitable configurations. Campaign parameters 504, which can be stored in a database, can be the same as campaign parameters 214 in FIG. 2. Job controller 508 receives from campaign parameters 504 (which can be directed by interface 502) content targets including rules that define acceptable video content to run an advertising campaign against. Job controller 508 also receives text metadata from third party video index 506. Third party video index 506 includes an index of Internet videos that can be maintained by one or more video search companies or other video sources, and outputs text metadata that can include the output of a video search.

Job controller 508 uses the data received from the interface 502, campaign parameters 504, and third party video index 50 to define and schedule jobs for one or more worker machines 512. For example, job controller 508 can determine which on-line videos should be scanned based on content targets, can determine how many worker machines 512 to assign to the tasks, and can allocate the selected on-line videos to the selected worker machines 512. Job controller 508 can include a process that determines the appropriate number of worker machines 512 needed to complete a scanning task, which can be adjusted (scaled) based on available resource and requirements. Job controller 508 then distributes a job to one or more worker machines 512, which can include a list of videos along with instructions on what information to look for in the videos (e.g., based on the content target).

In response to receiving a job from job controller 508, each assigned worker machine 512 downloads or ingests the assigned videos from the Internet 510 (e.g., from the publisher), scans the video for the content targets, and delivers the resulting attributes or visual metadata text to video database 514 for storage. Each worker machine 512 can be a computer, a network of computers, or any other suitable system. Although only four worker machines 512 are shown in FIG. 5, more or less worker machines can be used. In addition, the number of worker machines 512 used for each scanning task can vary depending on the number of videos to be scanned, the type and amount of information to be processed from the videos, the run-time requirements for processing the videos, resource availability, requirements, and/or any other suitable factors. Video database 514 can include visual metadata for all videos from Internet 510 that the worker machines 512 have scanned and processed. Video database 514 can be video database 212 in FIG. 2.

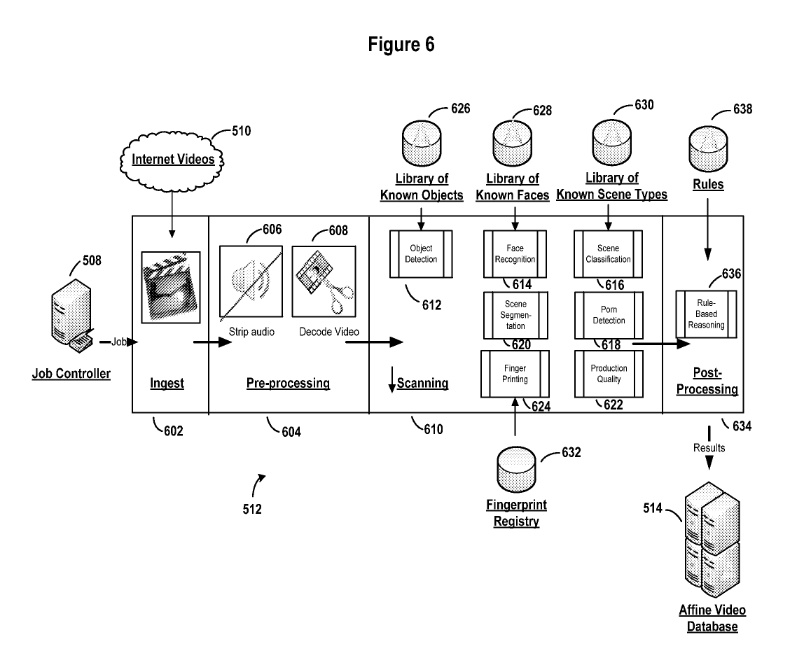

FIG. 6 is a block diagram illustrating an individual worker machine 512 in accordance with an embodiment of the invention. Worker machine 512 illustrates a pipeline by which videos are processed or scanned to generate attributes about the videos. A worker machine 512 that receives a job from job controller 508 goes through four processing steps: an ingest stage 602, a pre-processing stage 604, a processing or scanning stage 610, and a post-processing stage 634. During the ingest stage 602, a selected video is downloaded from the Internet 510 (e.g., from the publisher or hosting site). The downloaded video is then sent to the pre-processing stage 604 where the video is decoded and/or decompressed into separate audio data 606 and video or image data 608. FIG. 6 shows the decoded/decompressed audio data 606 as not being used. Alternatively, in another embodiment, audio data 606 can be used, for example, in the processing or scanning stage 610 for speech detection, fingerprinting, or any other suitable algorithm or combination of algorithms. In the pre-processing stage 604, the decoded/decompressed video data 608 can further be divided into individual frames. The data from the pre-processing stage 604 is then sent to the scanning stage 610.

Depending on the instructions that the worker machine 512 receives from job controller 508 on what information to look for in the selected video, scanning stage 610 can use one or more programs or algorithms to process or scan the video. The algorithms can include objection detection 612, face recognition 614, scene classification 616, pornography detection 618, scene segmentation 620, production quality 622, and fingerprinting 624.

The object detection algorithm 612 can identify an object in a video frame such as a logo (e.g., Nike™ swoosh, NBC peacock), a product (e.g., a cellular telephone, television), a human figure, a face, a character (e.g., Mickey Mouse, Snoopy) or any other suitable object.

The face recognition algorithm 614 can determine the identity of faces (e.g., Julia Roberts, Tom Hanks, David Letterman) in a video frame. In one embodiment, the face recognition algorithm 614 can use a type of object detection to identify faces. In such an embodiment, a video can be processed for faces using first the object detection algorithm 612 followed by the face recognition algorithm 614. In another embodiment, a video can be processed for faces using only the face recognition algorithm 614.

The scene classification algorithm 616 can determine the type of scene in a video such as a beach scene, a sporting event such as a basketball game, a talk show, or any other suitable scene.

The pornography detection algorithm 618 can be a type of scene classification to identify pornography. In one embodiment, a video can be processed for pornography using first the scene classification algorithm 616 followed by the pornography detection algorithm 618. In another embodiment, a video can be processed for pornography using only the pornography detection algorithm 618.

The scene segmentation algorithm 620 can identify scene breaks in a video. For example, a ball game may have the following scene sequences that can be identified: game footage, followed by booth chatter between play-by-plays, followed by game footage, followed by a crowd shot.

The production quality algorithm 622 can identify the production value of a video to determine whether the video is of high, average, or low production quality. For example, the production quality algorithm 622 can determine which the video was made using a webcam, a cellular telephone, a home video camera, is a slideshow, is of professional quality, or is of another source.

The fingerprinting algorithm 624 can use visual features in a video to calculate a unique signature and to identify the video by comparing this signature to other previously identified signatures.

The algorithms can be run serially, in parallel, or any combination thereof. Although FIG. 6 shows these seven types of algorithms, the scanning stage 610 can include any other suitable algorithm or combination thereof. For example, scanning stage 610 could further include algorithms that process audio data 606 and/or a combination of the audio data 606 and video data 608.

One or more of the algorithms can use an associated library, registry, or other database of data containing known variables (e.g., known objects, faces, scene types, fingerprints) that allow the algorithm to identify specific information about the video. For example, the object detection algorithm 612 can identify objects in a video frame based on data from a library of known objects 626. The face recognition algorithm 614 can identity faces in a video frame based on data from a library of known faces 628. The scene classification algorithm 616 can identify scene types in a video frame based on data from a library of known scene types 630. And the fingerprinting algorithm 624 can identity particular videos based on data from a fingerprint registry 632. Libraries 626, 628, and 630 and the fingerprint registry 632 can be stored in any suitable database or storage medium, including one or more servers, magnetic disks, optical disks, semiconductor memories, some other types of memories, or any combination thereof. Although libraries 626, 628, and 630 and fingerprint registry 632 are shown in FIG. 6 as being stored in separate databases, they could be separated or combined into any suitable number of databases. Data stored in libraries 626, 628, and 630 and the fingerprint registry 632 can be obtained from any suitable source including from one or more third party sources, from the processing of videos and identification of such known variables by the worker machines 512, or any combination thereof.

The raw data generated from the scanning stage 610 is then sent to the post-processing stage 634 where the raw results are rationalized using a rule-based reasoning algorithm 636. The rule-based reasoning algorithm 636 can use an associated database 638 containing rules that correlate the raw results to information about the video, and then stores the resulting video-level data in video database 514. For example, rule-based reasoning algorithm 636 can use the rules in database 638 to determine whether the video satisfies the content target from the campaign parameters 504. This can include, for example, determining whether the video contains a specified object, face, or scene, or whether the video contains pornography.

The follow provides an illustrative example of how the worker machine 512 can process a video in accordance with an embodiment of the invention.

### Ingest Stage

During the ingest stage 602, a video can be downloaded from the Internet 510 as a single file. The file can be a Flash video file (e.g., with a .flv file extension) or any other suitable file. The video file typically contains encoded and compressed audio and video.

### Pre-Processing Stage

During the pre-processing stage 604, the video file is decoded and decompressed into a series of individual images (the frames of the video). These frames can then be stored for subsequent processing by the various vision algorithms in the processing or scanning stage 610.

Also during the pre-processing stage 604, a variety of transformations can be performed on each of the frames. The results of the transformations can be stored for subsequent processing by the algorithms. The transformations can include, for example, resizing the frames to a canonical size, rotating the frames, converting frames to greyscale or other color spaces, and/or normalizing the contrast of the colors through histogram equalization. The transformations can also include calculating a summed area table for each frame, which can be a lookup table allowing the sum of the pixels in any region within the image to be calculated in constant time. Any other suitable transformation or combination of transformations can be performed on the frames for subsequent processing by the algorithms.

Also during the pre-processing stage 604, statistics can be calculated for the frames that are stored for subsequent processing by the algorithms. The statistics can include, for example, color histograms, edge direction histograms, and histograms of texture patterns (e.g., using local binary patterns or wavelet-based measures). Any other suitable statistics or combination of statistics can be calculated on the frames for subsequent processing by the algorithms. The statistics can be calculated for each frame as a whole, for one or more portions (e.g., quadrants) of each frame, on one or more frames, or any combination thereof.

Also during the pre-processing stage 604, the locations of one or more keypoints (or interest points) within the frames can be located using a keypoint finding algorithm such as Speeded Up Robust Features (SURF) or Scale-Invariant Feature Transform (SIFT). The located keypoints can then be stored. Keypoints are typically points in a video that tend to correspond to corners, ridges, and/or other structures whose appearance is somewhat stable from a variety of viewpoints and lighting conditions. This therefore allows the keypoint finding algorithm to pick up similar sorts of points on similar frames under different conditions. Associated with each keypoint is a region of interest around the keypoint, which can also be stored.

### Processing or Scanning Stage

During the processing or scanning stage 610, one or more algorithms can be used to process the data generated from the pre-processing stage 604.

Object Detection.

Object detection can be the process of identifying where in a video a specific object appears. The more well defined a shape is, such as a human face or a specific brand logo, the more reliably that object can be detected.

The object detection algorithm 612 examines one or more regions within each frame at one or more scales and/or locations to determine whether any of the regions contains an object of interest. Each of the regions at the different scales and/or locations can be examined serially, in parallel, or a combination thereof using any suitable (generic and/or specialized) hardware and/or software. For each region, a series of tests can be performed, all of which must pass in order for the region to be classified as detecting the object of interest. Once any test fails, the region can be immediately rejected, thus allowing object detection to be performed quickly.

The object detection algorithm 612 can perform an initial test that looks for a solid color or an otherwise “uninteresting” region. These can be identified quickly using the summed area table and/or other statistics that were previously calculated and stored during the pre-processing stage 604, thus allowing a large portion of regions to be eliminated with almost no computational effort. The object detection algorithm 612 can then perform subsequent tests that can include increasingly complex arithmetic comparisons involving histogram values, lines, edges, and corners in the region (which can be calculated using, for example, Haar-like wavelets and the summed area table for the frame). The exact features and comparisons used can be learned ahead of time using techniques such as Adaboost and manually-labeled examples of the object of interest.

The object detection algorithm 612 can determine an object to be detected in the frame when there are preferably several heavily overlapping regions that each appear to include the object. The quantity of regions needed can be learned empirically by using example videos. In addition, the object detection algorithm 612 can further determine an object to be detected in the video when the object shows up consistently for several frames. Motion tracking techniques can further be used to find unique appearances of an object.

The object detection algorithm 612 can use one or more object detectors for processing the frames. In order to simultaneously use a large number of object detectors efficiently, the object detectors are preferably organized into a tree structure where early tests are shared amongst multiple object detectors. This allows the early test to be performed once, thereby allowing a large percentage of regions to be eliminated from consideration for any detector with a small number of tests.

Face Recognition.

Face recognition is the process of determining the identity of a human face. Before face recognition can be applied, the exact or approximate locations of faces within a video is preferably first determined. This can take place during the object detection process using a human face detector. Additionally, object detectors for facial features such as the corners of the eyes and mouth can be used to determine which pixels are from which parts of the face. This can help compensate for variances in pose and camera perspective. Although face recognition is primarily described as determining the identity of a human face, face recognition could also be used to determine the identity of any other suitable face including comic book characters (e.g., Superman, Batman) and cartoon characters (e.g., characters from the Simpsons, Family Guy, Peanuts).

The face recognition algorithm 614 resizes the detected face to a canonical size and then extract the face pixels. The pixels can be concatenated to form a single high-dimensional vector. The dimensionality can then be reduced by applying a transformation that can be learned using examples of face pairs either containing images of the same person or of different people. The transformation preferably minimizes the distance in the transformed space between pairs of faces that are the same person and maximizes the distance between different people. If there is a small number of people of interest for recognition, the subspace can be learned specifically to maximize the distance between those people.

Once the face vector is transformed to the low-dimensional space, it is compared to a database of known face vectors (e.g., library 628). Nearest-neighbor techniques can be used to quickly find the known face closest to the face of interest. If a known face is found close to the face of interest, the face of interest is identified as being the person associated with the known face. If no match is found, the face vector for the face of interest is recorded in the database as an unknown person. As more faces of the same unknown person are processed and identified, that person may be selected to be automatically or manually identified in order to expand the database of known identities.

Scene Classification.

Scene classification is the process of characterizing the general appearance of the frames rather than finding specific objects and people at specific locations. For example, classes of scenes can include beach scenes, skiing scenes, office scenes, basketball games, or any other suitable scene. Each of these scenes has a distinct visual appearance in terms of the colors, textures, and other features that can show up in a frame.

The scene classification algorithm 616 classifies the video based on the regions extracted around the keypoints. Each region from each frame can be treated as a high-dimensional vector. This dimensionality can be reduced using a technique such as a principal component analysis with a transformation calculated ahead of time using example training videos.

These low dimensional vectors can then be quantized using an unsupervised clustering algorithm that has been trained using region vectors extracted from example videos. The distribution of region classes within each frame and through portions of the video can be calculated as a series of histograms. These histograms can then be used to classify the scene as a whole using a technique such as boosted weak learners or support vector machines. A library of classifiers for specific types of scenes is stored in a database (e.g., library 630).

Pornography Detection.

Pornography detection is the process of determining whether a video contains nudity or explicit sexual content. This can be treated as a special case of scene classification. Scene classifiers can be kept in a database (e.g., library 630 or a separate database from the one used for scene classification) for several levels of explicitness such as bikinis/partial nudity, full nudity, explicit sexual activity, and/or any other level of explicitness.

Scene Segmentation.

Scene segmentation is the process of determining when a transition in scene within a video occurs. A scene can be a portion of a video which occurs in a single location. Within a scene, there may be numerous individual camera shots, which can occur if the scene was filmed using multiple cameras. For example, a scene depicting a conversation between two people might alternate between shots of each person's face as they speak, but would be considered a single scene.

The scene segmentation algorithm 620 first finds the boundaries between the individual camera shots. Because the keypoints located and recorded during the pre-processing stage 604 are stable to small changes in perspective and lighting, subsequent frames within the same shot tend to have mostly the same keypoints in slightly different locations. At the beginning of a new shot, the majority of keypoints from the previous frames will disappear. Therefore, the scene segmentation algorithm 620 can locate shot breaks by tracking the keypoints from frame to frame and looking for frames in which most of the tracked keypoints disappear.

The visual statistics that were recorded during the pre-processing stage 604 (such as color histograms and edge directions) will tend to have different distributions in different scenes. Thus, the likelihood of a given time being a shot boundary can be determined by comparing the distributions of the various features in each candidate “shot” using, for example, the Kullback-Leibler divergence.

Once the shots are found, the scene segmentation algorithm 620 then groups them into scenes by comparing the keypoints and distributions of features in non-adjacent shots to locate similar ones. If there is a portion of the video that alternates between a set of similar shots, that portion is classified as a scene. There may be some videos that do not have scenes. For example, many music videos are made of many brief shots with no structure grouping them together.

When effects such as fades and wipes are used to transition between scenes, these transitions may not always be detected using these techniques. By their nature, fades and wipes are gradual transitions. Therefore, there is no single frame in which the majority of keypoints from the previous frame disappear or in which the statistics radically change. This can be solved by having explicit state machine models of commonly-used transition effects (e.g., fade, wipe, fade-to-black) that can be used to find these boundaries. It can also help to have models of camera pans and zooms since these can sometimes be mistaken for shot breaks.

Production Quality.

Production quality is the process of identifying “professional-looking” videos. This can include both the quality of the camera and the skill of the camera operator.

The production quality algorithm 622 analyzes the movement of the camera by tracking the keypoints from frame to frame to determine the amount of jitter. A professional video will typically have little to no jitter. By contrast, a video with a lot of jitter typically indicates amateur cellular telephone or home video footage. The overall color distribution within the video and other statistics can be used for comparison to known examples of professional and amateur video content.

The production quality algorithm 622 can also calculate the amount of blurring in various parts of the frame by examining the vertical and horizontal derivatives of the pixel values and considering the likelihood given convolution with a variety of blurring kernels. A professional video will typically have one part of the frame (the subject) that is in focus while the remainder (the background) is blurred. By contrast, an amateur video will typically be either entirely focused or entirely blurred.

If there appears to be a subject region (a single focused region with the rest of the frame blurred), the production quality algorithm 622 will compare the color distribution in the subject region to the rest of the frame (the background). A professional video will have brighter lighting on the subject than on the background. The background will also have less variation in its color so as to not distract from the subject. By contrast, an amateur video will usually be naturally lit, and thus have constant brightness and color distribution throughout the frame.

The production quality algorithm 622 can combine each of these factors into a single weighted score to determine how “professional” the video appears to be. The weighting between these various factors can be learned empirically using selected examples of various types of videos, including professional, webcam, and cellular telephone videos.

Fingerprinting.

Video fingerprinting is the process of comparing a video (or a portion thereof) to a database of known videos (or portions thereof) (e.g., registry 632) to determine whether the video has been seen before. Fingerprinting can only determine whether the video is an exact match (the same video) and cannot find “similar” videos (as in scene classification 616). However, fingerprinting can recognize a video even if it has been somewhat degraded or altered, for example, due to transcoding, transferring the content from television to a computer, or adding text or a logo over a portion of the video.

Rather than storing the original video, the fingerprinting database typically stores a numerical signature, called a fingerprint, for each video. In another embodiment, the fingerprinting database can store the original video rather than the fingerprint of the video. The fingerprinting algorithm 624 calculates the fingerprint of a video using a formula based on the keypoints in each frame as well as the other statistics calculated and stored during the pre-processing stage 604 (e.g., distribution of colors, edge directions and wavelets). If a candidate video has been degraded any from the original, the statistics may have drifted slightly, which can result in a fingerprint that is similar, but not identical, to that of the original video.

Because the database of known videos may be large, it is important to be able to quickly determine whether there are any fingerprints close to that of a candidate video. This can be accomplished by storing the fingerprints in a kd-tree or similar data structure, and using nearest-neighbor search techniques.

In an alternative embodiment, rather than calculating and storing fingerprints for the entirety of each of the known videos, the video can be sliced into segments (e.g., one second intervals or other suitable intervals), with the fingerprint of each segment stored in the database. The candidate video can similarly be sliced into the same segments (e.g., one second intervals or other suitable intervals), with the fingerprint of each segment compared against the corresponding fingerprints in the database. The fingerprinting algorithm 624 can then look for multiple matching segments in a row from the same source video to find larger sections of the video taken from a single source. Thus, the fingerprinting algorithm 624 can identify the video if it is a shorter clip taken from a longer source (e.g., a clip from a movie or sports game), and can identify mash-ups containing footage from multiple source clips even if not all of them are known.

### Post-Processing Stage

Rule-Based Reasoning.

During the post-processing stage 634, the results from the various vision algorithms from scanning stage 610 are combined to make final decisions regarding the content of the video. These decisions are based on rules that can be automatically learned and/or manually specified.

For example, a video can be classified as a “webcam” video if the production quality algorithm 622 indicates a low quality stationary camera, the object detection algorithm 612 identifies a single human face in roughly the center of the frame, and the scene segmentation algorithm 620 indicates that the video contains a single uninterrupted shot. The weights to use for each of these factors can be determined based on examples of videos from webcams and from other sources, or using any other suitable weights.

The rule-based video classifications and the raw results of the individual algorithms can be stored in a database (e.g., video database 514). This allows rules to be added or modified later and applied to already processed videos.

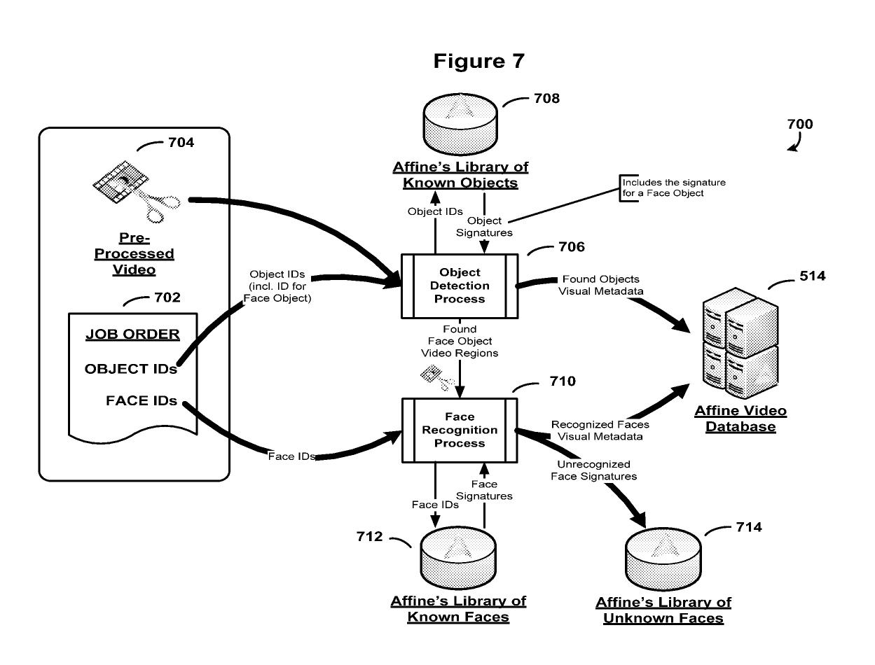

FIG. 7 is a flow chart illustrating a process for object detection and face recognition in accordance with an embodiment of the invention. The object detection process 706 (e.g., object detection algorithm 612 in FIG. 6) (which can be running on a worker machine 512) processes a pre-processed video 704 based on a job order 702. The pre-processed video 704 can be video data that has been processed for machine vision scanning during the pre-processing stage 604 (as shown in FIG. 6). The job order 702 can be a job handed off by the job controller 508 to the worker machine 512 (as shown in FIGS. 5 and 6), and includes instructions about what objects and faces to scan for in the video. The job order 702 can specify the objects in the form of Object IDs, which are ID numbers identifying the objects within the library of known objects 708. It can specify the faces in the form of Face IDs, which are ID numbers identifying the faces within the library of known faces 712. If the job order 702 includes faces, the Object IDs given will include the IDs for one or more generic human Face Objects, which can be used to find all faces within the video.

Using the Object IDs from job order 702, the object detection process 706 queries a library of known objects 708 (e.g., library 626 in FIG. 6) in exchange for object signatures, and then compares data from the pre-processed video 704 to the object signatures for any matches. Each known object, including the generic human face, has an object signature containing data that uniquely identifies the characteristics of that visual object (e.g., what the object looks like). The object signatures for all known objects are stored in the library 708. As objects become known, the object signatures for these objects can be added to the library 708. The results of the object detection process 706 include found objects visual metadata and, if a human face detector was included, found face object video regions. The found objects visual metadata can include what and where objects were found, and can be stored in video database 514. The found face object video regions can include visual data for the face regions in the video frame, and can be sent to face recognition process 710 (e.g., face recognition algorithm 614 in FIG. 6).

Using the Face IDs from job order 702, the face recognition process 710 queries a library of known faces 712 (e.g., library 628 in FIG. 6) in exchange for face signatures, and then compares data from the found face object video regions (from object detection process 706) to the face signatures for any matches. Each known face has a face signature containing data that uniquely identifies the characteristics of that face (e.g., what he or she looks like). The face signatures for all known faces are stored in the library 712. As faces become known, the face signatures for these faces can be added to the library 712. The results of the face recognition process 710 include recognized faces visual metadata and/or unrecognized face signatures. The recognized faces visual metadata can include what faces were recognized in which frames, and can be stored in video database 514. The unrecognized face signatures can include visual metadata for faces that have been found but not yet identified, and can be stored in a library of unknown faces 714. Subsequently, when a previously unknown face is identified, the face signature for that face can be added to the library 712. Although libraries 712 and 714 are shown as separate libraries, they can be combined into one database or divided into any suitable number of databases.

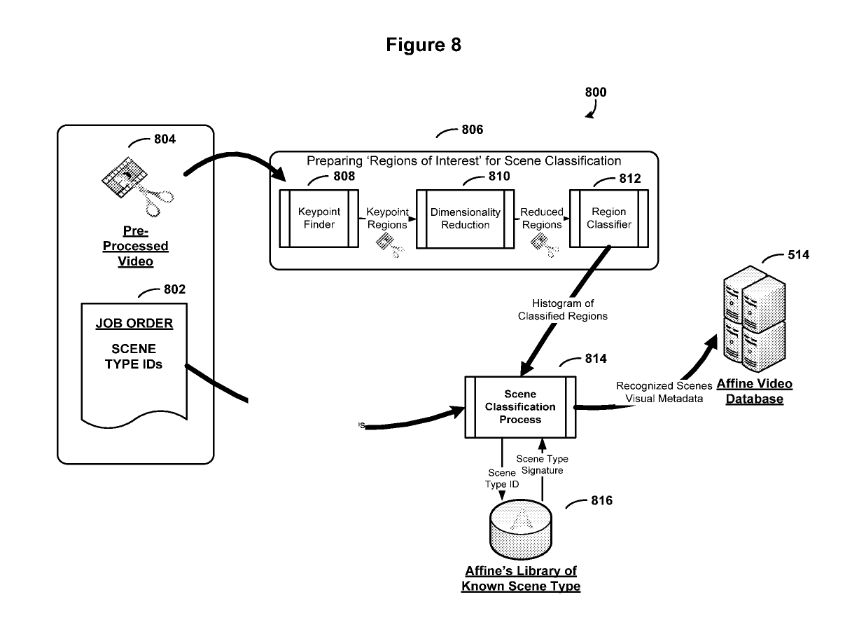

FIG. 8 is a flow chart illustrating a process for scene classification in accordance with an embodiment of the invention. The scene classification process 814 (e.g., part of scene classification algorithm 630 in FIG. 6) (which can be running on a worker machine 512) processes a pre-processed video 804 (which can be further processed as described below) based on a job order 802. The pre-processed video 804 can be video data that has been processed for machine vision scanning during the pre-processing stage 604 (as shown in FIG. 6). The job order 802 can be a job handed off by the job controller 508 to the worker machine 512 (as shown in FIGS. 5 and 6), and includes instructions about what types of scenes to scan for in the video. These can be specified in the form of Scene Type IDs, which are ID numbers of the types of scenes to scan for within the library of known scene types 816.

Regions of interest can be prepared for the pre-processed video 804. As shown in FIG. 8, the process can take place during the pre-processing stage 604. Alternatively, the process can take place during the processing stage 610 as part of the scene classification process 814. The process of preparing regions of interest includes examining multiple regions within a video frame and across a sequence of frames to reduce the data set from all of the data in a frame to only the relevant regions of data in a frame. The process can include any suitable technique or combination of techniques for preparing the regions of interest, including, for example the use of a keypoint finder 808, followed by a dimensionality reduction 810, and then followed by a region classifier 812. The keypoint finder 808, which can use known methods, identifies keypoints in frames and outputs the pixel data of regions surrounding and including the keypoints. The keypoints can be visual points of interest that can be defined by local stability. Next, the dimensionality reduction 810 distills the raw keypoint region data by discarding non-essential information. Finally, the region classifier 812 classifies regions into similar types, which can be based on previously seen regions in other videos. The region classifier 812 then generates a list of region classifications, which can be represented as a histogram or as another suitable representation, which is sent to the scene classification process 814.

Using the Scene Type IDs from job order 802, the scene classification process 814 queries a library of known scene types 816 (e.g., library 630 in FIG. 6) in exchange for scene type signatures, and then compares data from the prepared regions of interest 806 to the scene type signatures for any matches. Each known scene type has a scene type signature containing data that uniquely identifies the characteristics of that visual scene (e.g., what the scene looks like). The scene type signatures for all known scenes are stored in the library 816. As types of scenes become known, the signatures for these scenes can be added to the library 816. The results of the scene classification process 814 include recognized scenes visual metadata. The recognized scenes visual metadata can include what types of scenes were found, and can be stored in video database 514.

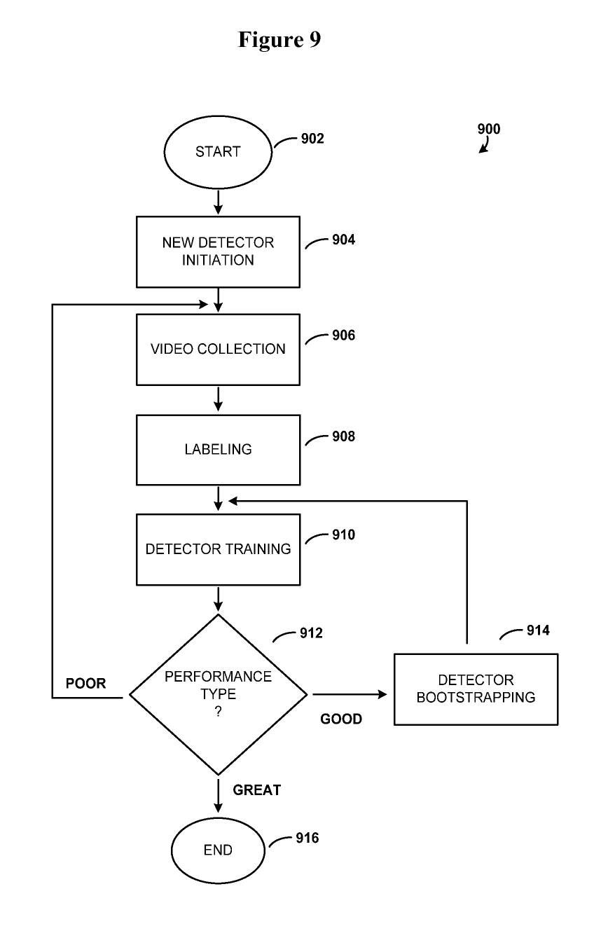

FIG. 9 is a flow chart illustrating a process 900 for learning visual signatures in accordance with an embodiment of the invention. In one embodiment, process 900 can illustrate how an optimized advertisement delivery system can learn to identify an object, face, scene, or any other suitable depiction or combination of depictions in a video. Process 900 can be implemented using any suitable system including, for example, system 104 (FIG. 1), system 204 (FIG. 2), job controller 508 (FIG. 5), one or more worker machines 512 (FIG. 5), one or more databases (FIG. 6), another suitable computer or network or computer, and/or any combination thereof.

Process 900 begins at step 902. New detector initiation occurs at step 904. During new detector initiation, an administrative user interface (e.g., Admin UI 502 in FIG. 5) can be used to create an empty detector, to input a description for the detector, and to input parameters for the detector. The parameters can include, for example, the size of the search for training videos, a priority, a due date, a minimum accuracy for the detector, and/or any other suitable parameters. Because there may be many detectors being trained at once, the job controller (e.g., job controller 508 in FIG. 5) can use a taskflow analysis to determine what job to queue up based on job status and the input from the administrative user interface. Process 900 continues once the controller decides to queue up initial video collection for the new detector.

Video collection occurs at step 906. During video collection, a video search engine can be used to collect a sample set of videos that are likely to include the object, face, and/or scene of interest. In one embodiment, the video sample set can include the URLs for the videos in the set. The collected video sample set can then be sent by the job controller to one or more worker machines (e.g., worker machines 512 in FIG. 5) where the videos identified in the set are downloaded from the Internet (e.g., the ingest stage 602 in FIG. 6) and pre-processed for video analysis (e.g., the pre-processing stage 604 in FIG. 6). The resulting video data is then stored in a database. The database can be a separate training database or part of another database (e.g., databases 626, 628, 630, and/or 514 in FIG. 6, or another suitable database). Process 900 continues once enough videos have been collected and the job controller (e.g., job controller 508 in FIG. 5) queues up labeling of the videos as the next task.

Labeling occurs at step 908 to identify occurrences of the object, face, and/or scene of interest in the video sample set. A labeling tool can be used to indicate which frames or portions of the videos contain the object, face, and/or scene of interest. The location of the object of interest can also be indicated by drawing a box or other shape around it (e.g., using a standard computer mouse), by clicking on it or by clicking on several keypoints (e.g., the corners of the object). Next, a tracking algorithm can be applied that attempts to guess the location of the object, face, and/or scene in subsequent frames. If the guessed location of the object, face, and/or scene in subsequent frames is incorrect, the labeling tool can be used to correct the location by removing the boxes or moving them to the correct locations. The job controller can use the taskflow analysis to determine when the job has sufficient data to build a detector.

Detector training occurs at step 910 to learn what a new object, face, and/or scene looks like using one or more supervised machine learning algorithms to build a unique signature for that object, face, and/or scene. During detector training, a training machine can run training algorithms to build an initial detector from one or more of the labeled frames from step 908. The machine can be a separate training machine, one or more of the worker machines 512 (in FIG. 5), the job controller 508, or any other suitable computer or network of computers. The training machine can record the detector signature generated from the training algorithms in a database (such as video database 514 in FIG. 5). The training machine can also run detection algorithms (e.g., object detection algorithm 612, face recognition algorithm 614, scene classification algorithm 616 in FIG. 6) to test the initial detector against the remainder of the labeled frames, and to record the performance of the new detector signature (e.g., in video database 514).

At step 912, process 900 evaluates the performance of the new detector signature. If the performance is poor, process 900 returns to step 906 for additional video collection and further processing. If the performance is great, the process ends at step 916. And if the performance is good (e.g., somewhere between poor and great), process 900 moves to step 914. The performance can be measured using any suitable technique, condition, and/or factor. For example, the performance can be measured by the number or percentage of times that the new detector signature accurately detects the corresponding object, face, and/or scene in the labeled frames for the video sample set. The required number or percentage can be set automatically or manually, can be fixed or variable, can be a predetermined number, or any other suitable factor. As an illustration, the performance can be considered poor if the new detector signature accurately detects a corresponding object less than 50% of the time, the performance can be considered great if the new detector signature accurately detects a corresponding object more than 90% of the time, and the performance can be considered good if the new detector signature accurately detects a corresponding object between 50-90% of the time.

Detector bootstrapping occurs at step 914 to improve the accuracy of the detector signature for that object, face, and/or scene (e.g., to improve the performance from good to great) by using the detector itself to collect additional training data. During detector bootstrapping, a new video sample set is collected that includes the object, face, and/or scene of interest. The new video sample set is then sent to one or more worker machines (e.g., worker machines 512 in FIG. 5) where the videos identified in the set are downloaded from the Internet (e.g., the ingest stage 602 in FIG. 6) and pre-processed for video analysis (e.g., the pre-processing stage 604 in FIG. 6). In one embodiment, the same video search engine used in step 906 can be used to collect the new video sample set. In another embodiment, system 104 (which can be a server or other computer), can use a web spider to collect the new video sample set. The worker machine (or other suitable machine) can then use an appropriate detection algorithm (e.g., object detection algorithm 612, face recognition algorithm 614, scene classification algorithm 616 in FIG. 6) in conjunction with the detector signature to determine the locations of the object, face and/or scene or interest in the new sample videos. The detector can be run with its sensitivity threshold set to the minimum so that it will find as many instances of the object of interest as possible at the expense of some incorrect detections (false positives). The detected locations are recorded in the label database. This can be a separate label database or part of another database (e.g., training database, databases 626, 628, 630, and/or 514 in FIG. 6, or another suitable database). Next, the job controller can use the taskflow analysis to determine the validation job ready to queue up. The labeling tool is then used to validate the results (indicate which of the locations recorded by the detector are correct) and to correct any that are erroneous. These validation results are stored in a database. The validated and corrected data is added to the original training data, and the process returns back to step 910.

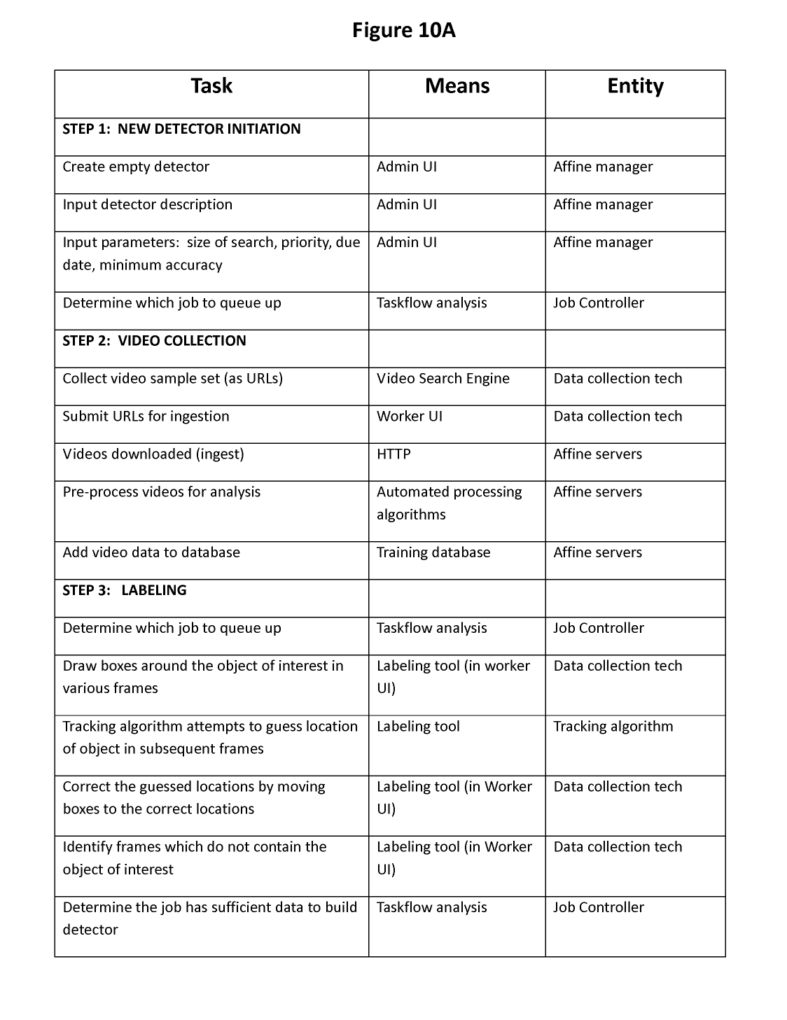

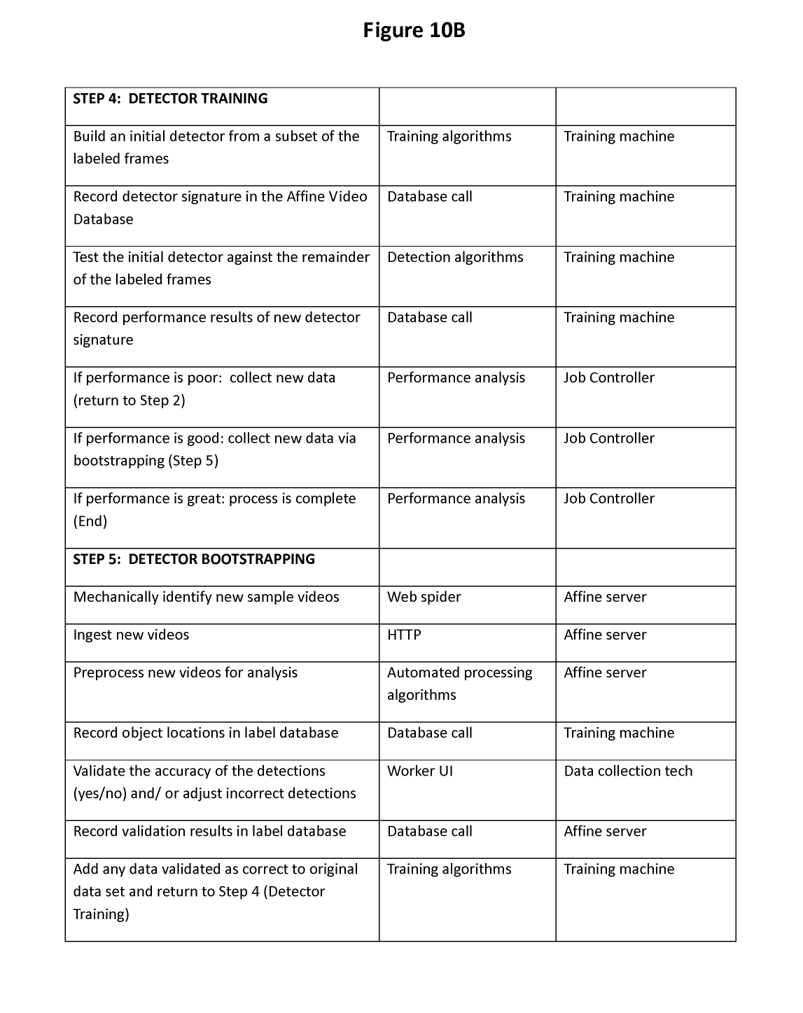

FIGS. 10A and 10B show an illustrative example of a process 1000 for learning visual signatures in accordance with an embodiment of the invention. Process 1000 includes five steps 1010, 1012, 1014, 1016, and 1018, which correspond to respective steps 904, 906, 908, 910/912, and 914 in process 900 (FIG. 9). Associated with each step 1010, 1012, 1014, 1016, and 1018 is an illustrative list of tasks 1002 performed as part of that step, the entity 1006 that can perform each task, and the means or ways 1004 that the entity 1006 can use to perform each tasks. The various tasks 1002 are illustrative and can include any suitable tasks or combination of tasks. The different entities 1006 are illustrative and can include any suitable entity, and can include any suitable automated system, manual system, and/or any combination thereof. The different means or ways 1004 are illustrative and can include any suitable means or ways, including any automated method, manual method, and/or any combination thereof. In addition, the different entities 1006 and means or ways 1004 can included any suitable automated system, including any suitable hardware and/or software needed to perform the corresponding tasks 1002.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method for learning visual signatures for identifying an element in a video comprising:
(A) initiating a detector for detecting the element in the video;
(B) collecting and storing a first plurality of video samples to a first database;
(C) labeling the stored first plurality of video samples by identifying occurrences of the element in the stored first plurality of video samples;
(D) training the detector by building a unique signature for the element based on the identified occurrences of the element in the stored first plurality of video samples;
(E) evaluating the detector by measuring an ability of the detector to detect the element in the video;
(F) when a result of evaluating the detector is below a first threshold, returning to step (B) to collect and store a second plurality of video samples; and
(G) when the result of evaluating the detector is above the first threshold, bootstrapping the detector, wherein bootstrapping comprises:
collecting a third plurality of video samples each containing the element; and
returning to step (D) to improve the accuracy of the detector.

2. The method of claim 1, wherein when the result of evaluating the detector is above a second threshold, terminating the method.

3. The method of claim 1, wherein initiating the detector comprises providing a detector description and detector parameters.

4. The method of claim 3, wherein the detector parameters comprise at least one of a size of search, priority, due date, and minimum accuracy.

5. The method of claim 1, wherein collecting the first plurality of video samples comprises:
receiving a plurality of uniform resource locators (URLs) each associated with one of the first plurality of video samples; and
downloading the first plurality of video samples at the plurality of URLs.

6. The method of claim 1, wherein labeling the stored first plurality of video samples further comprises indicating which frames or portions of the stored first plurality of video samples include the element.

7. The method of claim 6, wherein indicating the frames or portions of the stored video samples comprises drawing a shape around the element on the frames or portions of the stored first plurality of video samples.

8. The method of claim 6, further comprising tracking the element in subsequent frames of the stored first plurality of video samples.

9. The method of claim 6, further comprising estimating the location of the element in subsequent frames of the stored first plurality of video samples.

10. The method of claim 9, further comprising correcting the estimated location of the element.

11. The method of claim 1, further comprising storing the unique signature for the element in a second database.

12. The method of claim 1, wherein evaluating the detector comprises measuring a number of times the unique signature detects the element.

13. The method of claim 1, wherein evaluating the detector comprises measuring a percentage of times the unique signature detects the element.

14. The method of claim 1, wherein bootstrapping the detector further comprises validating the accuracy of the detector.

15. The method of claim 14, further comprising recording the validation results in the first database.

16. A system for learning visual signatures for identifying an element in a video, the system comprising:
a first database; and
a computer configured to:
(A) initiate a detector for detecting the element in the video;
(B) collect and store a first plurality of video samples to the first database;
(C) label the stored first plurality of video samples by identifying occurrences of the element in the stored first plurality of video samples;
(D) train the detector by building a unique signature for the element based on the identified occurrences of the element in the stored first plurality of video samples;
(E) evaluate the detector by measuring an ability of the detector to detect the element in the video;
(F) when a result of evaluating the detector is below a first threshold, return to step (B) to collect and store a second plurality of video samples; and
(G) when the result of evaluating the detector is above the first threshold, bootstrap the detector, wherein bootstrapping comprises:
collecting a third plurality of video samples each containing the element; and
returning to step (D) to improve the accuracy of the detector.

17. The system of claim 16, wherein the computer is configured to stop training the detector when the result of evaluating the detector is above a second threshold.

18. The system of claim 16, wherein initiating the detector comprises providing a detector description and detector parameters.

19. The system of claim 18, wherein the detector parameters comprise at least one of a size of search, priority, due date, and minimum accuracy.

20. The system of claim 16, wherein the computer collects the first plurality of video samples by:
receiving a plurality of uniform resource locators (URLs) each associated with one of the first plurality of video samples; and
downloading the first plurality of video samples at the plurality of URLs.

21. The system of claim 16, wherein the computer is configured to label the stored first plurality of video samples by further indicating which frames or portions of the stored first plurality of video samples include the element.

22. The system of claim 21, wherein the computer indicates the frames or portions of the stored video samples by drawing a shape around the element on the frames or portions of the stored first plurality of video samples.

23. The system of claim 21, wherein the computer is further configured to track the element in subsequent frames of the stored first plurality of video samples.

24. The system of claim 21, wherein the computer is further configured to estimate the location of the element in subsequent frames of the stored first plurality of video samples.

25. The system of claim 24, wherein the computer is further configured to correct the estimated location of the element.

26. The system of claim 16, wherein the computer is further configured to store the unique signature for the element in a second database.

27. The system of claim 16, wherein the computer is configured to evaluate the detector by further measuring a number of times the unique signature detects the element.

28. The system of claim 16, wherein the computer is configured to evaluate the detector by further measuring a percentage of times the unique signature detects the element.

29. The system of claim 16, wherein the computer is configured to bootstrap the detector by further validating the accuracy of the detector.

30. The system of claim 29, wherein the computer is further configured to record the validation results in the first database.
